(19) United States
(12) Patent Application Publication
(10) Pub. No.: US 2021/0308723 A1
(43) Pub. Date: Oct. 7, 2021

(54) CONTACTLESS CLEANING APPARATUS WITH TURBULENT FLOW

(71) Applicant: EJOT GmbH & Co. KG, Bad Berleburg (DE)

(72) Inventor: Mathias Dornbach, Erndtebrück (DE)

(21) Appl. No.: 17/290,421

(22) PCT Filed: Nov. 4, 2019
(86) PCT No.: PCT/EP2019/080075

§ 371 Date: Apr. 30, 2021

(30) Foreign Application Priority Data
Nov. 16, 2018 (DE) 10 2018 219 696.6

(51) Int. Cl. B08B 5/02; B08B 6/00; B08B 15/04

(52) U.S. Cl. CPC B08B 5/023; B08B 15/04; B08B 6/00

(57) ABSTRACT

An apparatus (1) for contactless cleaning of a workpiece as well as a corresponding method are described. The apparatus (1) comprises a first hollow body (2), wherein the first hollow body (2) is configured to at least partially receive the workpiece to be cleaned, a second hollow body (3), wherein the second hollow body (3) at least partially surrounds the first hollow body (2), and a movable nozzle ring (4) located between the first hollow body (2) and the second hollow body (3) for flow of media between the first hollow body (2) and the second hollow body (3), wherein the nozzle ring (4) is movable by ease of a drive (6).

The current invention relates to a contactless cleaning apparatus, in particular a cleaning apparatus for removing particles adherent on a workpiece, as well as a corresponding method.

During manufacturing of workpieces, in particular workpieces made of plastics, manufacturing conditions or machining of the workpiece during the manufacturing process, for example milling or rubbing of the workpiece, often lead to particles adhering on the surface of the workpiece to be manufactured or to be machined. These particles not only degrade the appearance of the finished product, but also may be prejudicial to further treatment steps, for example if the workpiece is to be varnished among others. Further, it is possible that workpieces are manufactured or machined that are so small that the adhering particles already hinder the proper functioning of the workpiece, for example if the workpiece is part of precision engineering.

In order to remove such particles from the surface of the workpiece, the workpiece usually is sprayed with pressurized air, so that the particles are blown off of the surface.

Such blowing off the particles may have the advantage that the surface of the workpiece is freed from particles, but it also leads to scattering the particles in the surroundings and therefore the particles may adhere to the workpiece again afterwards. An additional drawback arises in a clean room location. If particles are scattered in the surroundings, the clean room will be contaminated.

Therefore, there is a need for providing an apparatus and a method, which do not posses the aforementioned drawbacks but provide a simple, contactless cleaning of a workpiece without a need for complex and cost-intensive assemblies and which avoid contamination of the surroundings. Furthermore, there is a need for providing an apparatus, which does not operate with pressurized air.

This need is overcome by an apparatus for contactless cleaning of a workpiece according to the current invention, wherein the apparatus comprises a first hollow body, which is configured to at least partially receive the workpiece to be cleaned. The hollow body surrounds a defined space. The hollow body may comprise at least one input opening, which is dimensioned in a way that the workpiece to be cleaned can at least partially be inserted into the hollow body. Furthermore, the hollow body may comprise a second input opening, which may also be referred to as output opening. This output opening may be configured to be connected to a negative pressure source, such that a suction is generated between the input opening and the output opening. This suction provides an air flow within the first hollow body. The person skilled in the art will appreciate that even if it is referred to an air flow, a flow of a medium in which the apparatus according to the invention is utilized is generated. For example, if the apparatus according to the invention is utilized in an inert gas atmosphere, a flow of the inert gas is generated. Generally, it may be said that a flow of the medium in which the apparatus is utilized is generated.

The apparatus according to the invention further comprises a second hollow body, which at least partially surrounds the first hollow body. Thereby, both hollow bodies may comprise a common input or output opening, respectively. For example, the first and second hollow bodies may form a coaxial tube, i.e. a tube in a tube, wherein the inner tube is formed by the first hollow body and the outer tube is formed by the second hollow body. The person skilled in the art will appreciate that even if it is referred to tubes, said hollow bodies may have an arbitrary geometry, for example may be formed angular or oval.

According to the invention, a connection between both hollow bodies is made in form of a movable nozzle ring, which allows for media flow between the first hollow body and the second body. For example, additionally to the suction generated within the first hollow body, air may be blown into the first hollow body via the second hollow body and the nozzle ring. Caused by the nozzle ring being movable and for example being driven by a drive, the air blown into the first hollow body will be twisted, such that a turbulent flow is generated within the first hollow body. Said turbulent flow allows for increased air flow application on the workpiece to be cleaned. Furthermore, the turbulent flow provides the advantage that the air flow will impact the workpiece to be cleaned in consistently different angles and may therefore blow off the adhering particles better. The removed particles are sucked in direction of the negative pressure source through the first hollow body and therefore do not reach the surroundings. Caused by the generated turbulent flow, already a small negative pressure is sufficient for the air flow achieving an increased cleaning effect. Thus, the output opening of the first hollow body may be connected to a suction input of an air blower, whereas the input opening of the second hollow body may be connected to the outlet of the air blower. Thereby, air is circulated between the first and second hollow bodies. It may also be said that the air blower sucks air from the first hollow body and blows said air into the first hollow body via the second hollow body and the movable nozzle ring.

The apparatus according to the invention therefore provides the advantage that a simple cleaning of a workpiece is possible without contaminating the surroundings. A further advantage of the apparatus according to the invention is that no pressurized air is necessary for cleaning the workpiece, this means that neither oil nor condensation separators are necessary, which would be essential for pressurized air cleaning.

In one preferred embodiment of the invention, the first hollow body, for example, comprises, at its input opening, an ionizer for removing particles that adhere to the surface of the workpiece statically. The ionizer may emit ions by ease of a connectable high voltage, wherein the air or medium flowing around the ionizer will be at least partially ionized. If the ionized air flow is directed to the surface of the workpiece directly, the surface of the workpiece will be electrostatically discharged and the statically adhering particles can be blown off. The ionizer may comprise a plurality of ionizer tips. Said ionizer tips may also be referred to as emitter tips and may be connected to a high voltage source. The ionizer tips may be arranged circumferentially at or in the input opening of the first hollow body. Such an arrangement of the ionizer tips may also be referred to as ionizer crown or ionizer ring. The ionizer tips may all emit same charged ions or different ionizer tips may emit differently charged ions. Thereby, it is achieved that it can be accounted for different surface charge profiles, this means that caused by ions of both polarities can be emitted, the static charge may be neutralized and the static adherence of the particles may be removed. Thereby, for example ionizer tips emitting positive ions may be alternated with ionizer tips emitting negative ions. Further, it is also possible that two ionizer crowns are arranged offset to one another, wherein one ionizer crown emits ions of a particular polarity.

In a preferred embodiment of the invention, the nozzle ring comprises at least one nozzle. Said at least one nozzle may allow a flow of media between the first and second hollow bodies. Because of the motion of the nozzle ring, the at least one nozzle does not remain stationary at one location, but changes its position over time. The nozzle also may be configured such that its orientation is adjustable and may be changed during the motion of the nozzle ring. The adjustment may for example be changed during a rotation of the nozzle ring. Furthermore, it is also possible that the at least one nozzle may be changed in shape and size, such that the flow of media may be adjusted in a targeted fashion. Also, a plurality of nozzles may be configured between the first and second hollow bodies. Said nozzles may for example be exchangeable depending on the application, such that the flow of media, for example, may be adjusted to the geometry of the workpiece to be cleaned. Further, during the insertion of the workpiece into the first hollow body, for example a contactless scanning of the workpiece may be performed and the at least one nozzle may be adjusted automatically in such a way that it allows for generating an optimized flow of media matching the geometry of the workpiece. The same also applies to the motion of the nozzle ring, which may also be adjusted to the shape and geometry of the workpiece. If the geometry of the workpiece is known, it is also possible that the at least one nozzle and its adjustment mechanism is adjusted in such a way that an automatic adjustment of the at least one nozzle and a corresponding motion of the nozzle ring based on the insertion depth of the workpiece within the first hollow body is performed.

In a further preferred embodiment of the invention, a drive moves the movable nozzle ring. This moving may be a direct moving or an indirect moving. For example, the drive may be coupled to the nozzle ring, so that the motion of the drive is transferred to the nozzle ring directly and the latter is moved according to the motion of the drive. However, it is also possible that the drive is coupled to the nozzle ring indirectly, for example by ease of a transmission, a gear assembly or a driving belt. In this case, the motion of the drive is not transferred to the nozzle ring directly. This has the advantage that the drive may be arranged offset to the nozzle ring. In the mentioned examples, the motion of the drive is, for example, transferred to the transmission, the gear assembly or the driving belt first and then to the nozzle drive. The person skilled in the art is, however, aware that the transfer of the motion is only exemplary and also other possibilities of transfer are also encompassed. An electric motor or a pneumatic motor may be utilized as drive. The motor may, for example, also be a portion of the nozzle ring. It is also possible that the motor is part of the first or second hollow body or separately thereto. The drive may, however, also be realized by the design of the nozzle ring itself, such that the nozzle ring may comprise fins, vanes or the like, which move the nozzle ring by ease of the air flowing into the first and/or second hollow bodies.

In another further embodiment of the invention, the first and/or the second hollow body comprises at least one filter. The at least one filter may, for example, be arranged in or at the output opening of the first hollow body. Said filter may receive the blown off particles, such that they do not even reach the negative pressure source connected to the output opening. The at least one filter may be exchangeable. The person skilled in the art is aware that not only one filter may be deployed, but a plurality of filters, which may, for example, filter different sized particles. Additionally or alternatively, at least one filter may be arranged at the input opening of the second hollow body. This at least one filter then may prevent particles from ending up in the air flow through the nozzle ring onto the workpiece to be cleaned. Also, said filter may be exchangeable and may consist of multiple filters.

In another preferred embodiment of the apparatus according to the invention, the apparatus further comprises a holding means for holding the workpiece in a particular position within the first hollow body. For example, the holding means may hold the workpiece in a particular position within the first hollow body. It is also possible that the holding means holds the workpiece and moves it at least partially in the first hollow body. Thereby, the holding means may produce a rotation of the workpiece within the first hollow body, such that the air flow may flow around the entire surface of the workpiece optimally and adhering particles are removed.

In another preferred embodiment of the apparatus according to the invention, the first hollow body comprises a limiting means, which prevents that the workpiece is inserted into the hollow body too deeply or is sucked in by the negative pressure source. For example, the hollow body may comprise a grid at its inside, which is configured in such a way that it retains the workpiece in case that the latter is sucked in by the negative pressure source.

In another preferred embodiment of the apparatus according to the invention, the workpiece to be cleaned is inserted into the first hollow body and moves through it. Thereby, the workpiece to be cleaned may either be restraint-guided by a means or may move caused by gravity. In the latter case, it may also be said that the workpiece to be cleaned falls through the apparatus and is cleaned during the falling.

In another preferred embodiment of the apparatus according to the invention, the apparatus comprises a further opening through which another medium may be led into the first hollow body. Said further medium may for example be different from the medium, which is sucked through the first hollow body. Said further medium may, for example, be a cleaning medium.

In another preferred embodiment of the apparatus according to the invention, the apparatus comprises at least one pressure sensor or air amount measurement device in the area of the input opening of the first hollow body, which is coupled to a controller. The controller is able to control the negative pressure source based on the measured values, as well as controlling the positive pressure source, if any, and the motion of the nozzle ring.

In another preferred embodiment multiple apparatuses according to the invention may be arranged in succession in a cascading fashion. Here, the apparatuses may either be arranged directly in succession, i.e. the at least one output opening of the first hollow body in a first apparatus may be connected to an input opening of the first hollow body of the second apparatus and so on, or the apparatuses may be arranged in a distance from one another. The workpiece to be cleaned may be moved or may fall through all apparatuses arranged in succession, such that different degrees of contamination may be removed.

The abovementioned need is also fulfilled by a method according to the contactless cleaning of a workpiece. The method according to the invention comprises at least partially inserting the workpiece to be cleaned in a first hollow body via a first input opening of the first hollow body, generating an air flow in the first hollow body by blowing air into the first hollow body by ease of a movable nozzle ring, wherein the movable nozzle ring is arranged between the first hollow body and the second hollow body, wherein the second hollow body at least partially surrounds the first hollow body, and simultaneously moving the nozzle ring.

In another preferred embodiment of the method according to the invention, the method comprises emitting ions into the air flow.

In another preferred embodiment of the method according to the invention, the method comprises the moving of the workpiece to be cleaned in the generated air flow. Said moving the workpiece may for example be achieved by a holding means, which rotates the workpiece to be cleaned within the first hollow body, such that the air flow may flow around the workpiece optimally and the particles adhering to the surface may be blown off. The workpiece to be cleaned may for example be moved through the apparatus, i.e. from the input opening of the first hollow body to an output opening of the first hollow body.

In another preferred embodiment of the method according to the invention, the method comprises the removal of the workpiece from the first hollow body after completion of the cleaning procedure. This means that the workpiece is removed from the first hollow body via the input opening through which it was inserted. This has the advantage that the workpiece is not moved in direction of the particles that are blown off, such that there is no risk of the workpiece being contaminated again.

In the following, the invention will be described in more detail on the basis of one embodiment example, which is depicted in the attached figures. Further details, features and advantages of the subject-matter of the invention arise from the described embodiment example. It shows:

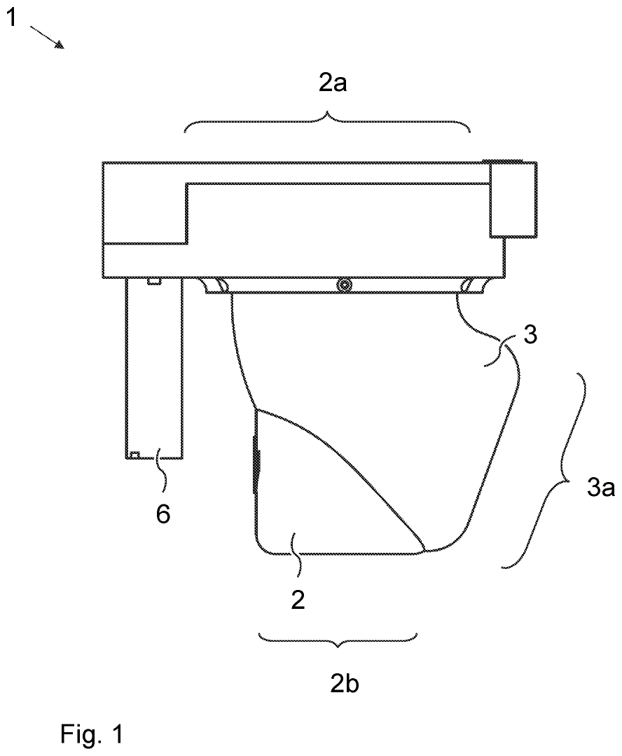

FIG. 1 a view of an embodiment example of an apparatus according to the invention;

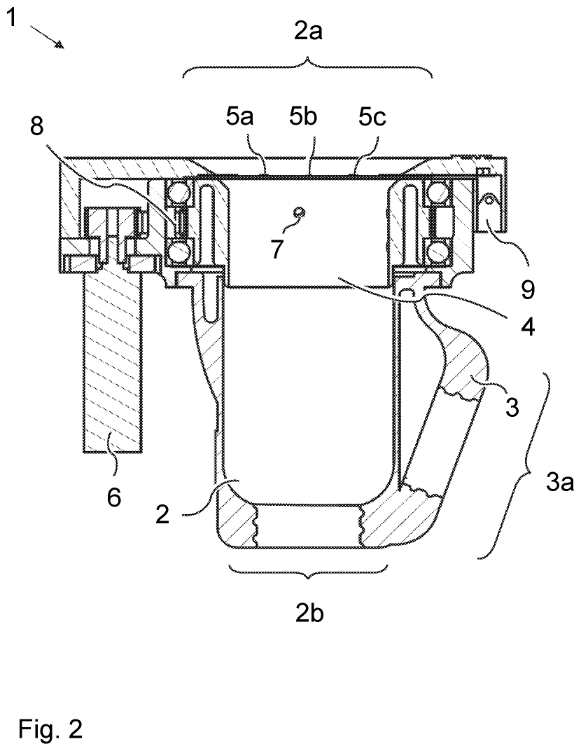

FIG. 2 a vertical cross-section of the embodiment example of the apparatus according to the invention depicted in FIG. 1, and

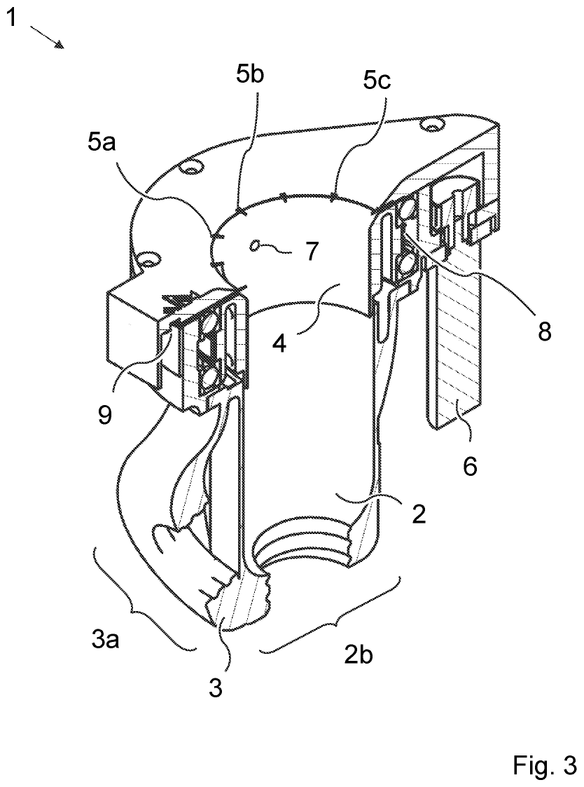

FIG. 3 a 3D view of the vertical cross-section depicted in FIG. 2 through the embodiment example of the apparatus according to the invention depicted in FIG. 1.

FIG. 1 illustrates an embodiment example of an apparatus 1 according to the invention. In the illustrated embodiment example, the apparatus 1 comprises an arrangement formed by coaxial tubes. This means that the apparatus 1 consists of an inner tube 2—which represents a first hollow body—which comprises an input opening 2a as well as an output opening 2b. Between the first opening 2a and the second opening 2b, media may flow. In the illustrated embodiment example, the apparatus 1 further comprises a second tube 3—which represents a second hollow body—, which at least partially surrounds the first tube 2. It may be said that the first tube 2 is the inner tube or the inner hollow body and that the second tube is the outer tube or the outer hollow body. The second tube 3 comprises an input opening 3a and is in its inside connected to the first tube 2 in the depicted embodiment example, such that flow of media between the input opening 3a of the second tube 3 and the first tube 2 is possible. For example, the outlet of a blower may be connected to the opening 3a, such that a medium may be blown from the outer tube 3 to the inner tube 2, whereby flow of media within the first tube 2 develops from its input opening 2a to its output opening 2b. Then, in order to increase the air flow, a negative pressure source, which may additionally suck air from the inner of the first tube 2, may be connected to the output opening 2b of the first tube 2. The negative pressure source may for example be the inlet of the blower, by which air is blown into the first tube 2 via the input opening 3a of the second tube 3. The flow of media within the first tube 2 causes that when a workpiece to be cleaned is moved through the input opening 2a into the tube 2, the generated flow of media will surround the workpiece. Thereby, adhering particles are blown off and will move in direction of the output opening 2b of the first tube 2, where these particles may be received by a filter—not shown here.

In order to achieve optimal air flow around the workpiece, a moving nozzle ring—not shown here—is arranged between the connection of the first tube 2 and the second tube 3. Said nozzle ring guides the air blown into the second tube 3 into the first tube 2 via at least one nozzle, wherein turbulent flow, which not only increases the suction within the first tube 2, but also provides for the air flow impacting the workpiece to be cleaned in different angles, is generated by the motion of the nozzle ring. In the embodiment example depicted here, the nozzle ring is moved via a drive 6.

In order to loosen statically adhering particles from the workpiece, an ionizer—here not shown—may be arranged in or at the input opening 2a, which may emit ions via high-voltage, which lead to neutralizing the surface charge of the workpiece, so that the otherwise statically adhering particles can be blown off.

FIG. 2 illustrates a vertical cross-section of the embodiment example of the apparatus 1 according to the invention illustrated in FIG. 1. In the illustrated embodiment example, the inner tube 2 is at least partially surrounded by the outer tube 3. In the illustrated embodiment example, between the first and second tubes 2, 3 a nozzle ring 4 is arranged, which in the illustrated embodiment example comprises at least one nozzle 7. If, for example, a blower is connected to the input opening 3a of the outer tube 3, air is blown through the nozzle 7. Thereby, a media flow is created between the nozzle 7 and the inner tube 2. Caused by the Bernoulli effect, the medium is sucked also through the input opening 2a by the media flow, so that a media flow is created between the input opening 2a and the output opening 2b. In the embodiment example illustrated here, the input opening 2a is funnel-shaped in order to facilitate the media flow. Additionally, the output opening 2b may also be connected to a negative pressure source. By the motion of the nozzle ring 4, which in the embodiment example illustrated here represents a restriction between the cavity of the first tube 2 and the cavity of the second tube 3 and which separates them, air flows only through the at least one nozzle 7 between the second tube 3 and the first tube 2. If the nozzle ring 4 is moved by ease of a drive 6, the position of the at least one nozzle 7 is changed over time. It may also be said that the at least one nozzle 7 moves on a circular path. By the motion of the nozzle ring 4 and thereby the at least one nozzle 7, a cyclic turbulent flow is generated in the first tube 2. Said turbulent flow not only increases the Bernoulli effect and thereby causes a stronger suction, but also provides for the workpiece to be cleaned is exposed to the air flow in different angles. The nozzle ring 4 may be coated with a material, which comprises a low friction coefficient, so that the friction between the nozzle ring 4 and the first and second tube 2, 3 is as low as possible. It is also possible that the nozzle ring 4 and/or the first and second tube 2, 3 are coated with a material, which has a low friction coefficient, only at the contact positions between the nozzle ring 4 and the first and second tube 2, 3.

In the here illustrated embodiment example, the nozzle ring 4 is moved by ease of a drive 6, which is connected to the nozzle ring 4 via a gear assembly 8. For this, the nozzle ring 4 comprises a gear-ring at its outside, i.e. the side facing the second tube 3, which is put into contact with the gears of the assembly 8, which in turn is connected to a gear of the drive 6. The gear assembly 8 thereby acts as a gearing mechanism between drive 6 and nozzle ring 4, so that the revolutions per minute of the nozzle ring 4 are higher compared to the revolutions per minute of the drive 6. However, the person skilled in the art is aware that the described example of the motion transfer is only exemplary and other motion transfers are also encompassed. For example, it is possible that a driving belt extends around the nozzle ring 4, which is moved by ease of the drive 6. However, it is also possible that the drive 6 itself is part of the nozzle ring 4. Further, the nozzle ring 4 may comprise fins or vanes, which cause that the nozzle ring 4 is set into motion by ease of the air blown into the input opening 3a of the second tube 3.

In the illustrated embodiment example, the apparatus 1 comprises ionizer tips 5a, 5b, 5c circumferentially around the input opening 2a of the first tube 2, which form an ionizer 5. Thereby, the ionizer 5 is connectable to a high-voltage source via a connection 9. By ease of the high-voltage, ions are created at the ionizer tips 5a, 5b, 5c, which are able to neutralize the static charge of the workpiece. The ions emitted by the ionizer tips 5a, 5b, 5c are carried by the generated flow of media into the inner tube 2 and may hit the workpiece to be inserted, where a corresponding neutralization takes place.

FIG. 3 illustrates a 3D view of the vertical cross-section of FIG. 2 through the embodiment example of the apparatus according to the invention illustrated in FIG. 1. In the illustrated embodiment example, the output opening 2b of the inner tube 2 and the input opening 3a of the outer tube 3 are furnished with threads in order to connect negative pressure and positive pressure sources to the respective openings.

The person skilled in the art will appreciate that the illustrated embodiment example is of exemplary nature and every illustrated element, means, component, and feature may be formed differently, but will still fulfill the basic functionalities, which are described here.

1. An apparatus for contactless cleaning of a workpiece, the apparatus comprising:
a first hollow body, wherein the first hollow body is configured to at least partially receive the workpiece to be cleaned;
a second hollow body, wherein the second hollow body at least partially surrounds the first hollow body; and
a movable nozzle ring located between the first hollow body and the second hollow body for flow of media between the first hollow body and the second hollow body, wherein the nozzle ring is movable by ease of a drive.

2. The apparatus according to claim 1, wherein the first hollow body comprises at least one ionizer.

3. The apparatus according to claim 2, wherein the ionizer comprises a plurality of ionizer tips, which are located circumferentially around an input opening of the first hollow body.

4. The apparatus according to claim 3, wherein the ionizer tips are configured to emit differently charged ions.

5. The apparatus according to claim 2, further comprising:
a high voltage source connected to the ionizer.

6. The apparatus according to claim 1, wherein the first hollow body is configured to be connected to a negative pressure source.

7. The apparatus according to claim 1, wherein the second hollow body is configured to be connected to a positive pressure source or a negative pressure source.

8. The apparatus according to claim 1, wherein the nozzle ring comprises at least one nozzle for controlling the flow of media between the first hollow body and the second hollow body.

9. The apparatus according to claim 1, wherein the apparatus further comprises:
a drive for moving the nozzle ring.

10. The apparatus according to claim 9, wherein the drive is an electric motor or a pneumatic motor.

11. The apparatus according to claim 1, wherein the first hollow body and/or the second hollow body comprises at least one filter.

12. The apparatus according to claim 1, further comprising:
a holding means for holding the workpiece to be cleaned.

13. A method for contactless cleaning of a workpiece, the method comprising:
at least partially inserting the workpiece to be cleaned into a first hollow body via a first input opening of the first hollow body;
generating an air flow within the first hollow body by means of blowing air into the first hollow body via a movable nozzle ring, wherein the movable nozzle ring is located between the first hollow body and a second hollow body, wherein the second hollow body surrounds the first hollow body at least partially; and
simultaneously moving the nozzle ring.

14. The method according to claim 13, further comprising:
emitting ions into the air flow.

15. The method according to claim 13, further comprising:
moving the workpiece to be cleaned in the generated air flow.
